(19) United States
(12) Patent Application Publication
(10) Pub. No.: US 2026/0175172 A1
(43) Pub. Date: Jun. 25, 2026

(54) EXHAUST GAS TREATMENT FURNACE, AND EXHAUST GAS TREATMENT DEVICE IN WHICH EXHAUST GAS TREATMENT FURNACE IS USED

(71) Applicant: KANKEN TECHNO CO., LTD., Kyoto (JP)

(72) Inventor: Hiroshi IMAMURA, Kyoto (JP)

(21) Appl. No.: 19/398,704

(22) Filed: Nov. 24, 2025

(30) Foreign Application Priority Data
Dec. 23, 2024 (JP) 2024-226135
Mar. 11, 2025 (JP) 2025-038464

(51) Int. Cl. B01D 53/76; B01D 47/06; B01D 53/56; B01D 53/70

(52) U.S. Cl. CPC B01D 53/76; B01D 47/06; B01D 53/56; B01D 53/70; B01D 2251/208; B01D 2257/2066; B01D 2257/402; B01D 2258/0216; B01D 2259/10; B01D 2259/122

(57) ABSTRACT

A exhaust gas treatment furnace includes: a furnace body including a gas treatment space and a gas discharge port formed in a center part of a bottom surface thereof; an electric heater hung centrally from the furnace body ceiling; and a ceramic inner tube of which a rear end is mounted on the bottom of the furnace body so as to enclose a circumferential edge of the gas discharge port, and of which a front end is open close to the furnace body ceiling and encloses an outer circumference of the electric heater. A gas introduction port is formed in one of the ceiling and the bottom of the furnace body, such that an exhaust gas inside the gas treatment space flows along an axial direction on an outer side of the ceramic inner tube, then reverses, and flows along an inner side of the ceramic inner tube.

### CROSS REFERENCE TO RELATED APPLICATION

The present application claims priority to Japanese Patent Application No. 2024-226135 filed on Dec. 23, 2024, and to Japanese Patent Application No. 2025-038464 filed on Mar. 11, 2025. The entire contents of the above-listed applications are hereby incorporated by reference for all purposes.

### BACKGROUND OF THE DISCLOSURE

### Field of the Disclosure

The present disclosure relates to an exhaust gas treatment furnace suitable for an abatement process of an exhaust gas mainly including a hardly decomposable CF₄ and the like, and an exhaust gas treatment device in which the exhaust gas treatment furnace is used.

### Description of the Background Art

In a manufacturing process for a semiconductor device or a liquid crystal display, gases of various kinds of fluorine compounds are used as a cleaning gas, an etching gas, and the like. Such fluorine compounds are referred to as “PFCs”, and typical examples thereof include: perfluorocarbons such as CF₄, C₂F₆, C₃F₈, C₄F₈, and C₅F₈; hydrofluorocarbons such as CHF₃; and inorganic fluorine-containing compounds such as SF₆ and NF₃. In the manufacturing process for a semiconductor device, etc., as a material gas for producing a nitride film, N₂O (nitrous oxide) and the like are used. Various kinds of PFCs, N₂O, and the like used in the manufacturing process for a semiconductor device or a liquid crystal display are discharged as an exhaust gas together with N₂, Ar, and the like used as, for example, a carrier gas and a purge gas. Throughout the present description, this exhaust gas is referred to as “semiconductor manufacturing exhaust gas”, or simply referred to as “exhaust gas”. In addition, a manufacturing process for a semiconductor device and a manufacturing process for a liquid crystal display are collectively referred to as “semiconductor manufacturing process”.

Here, the proportion of PFCs, N₂O, and the like in the entire exhaust gas is small compared to those of other gases such as N₂ and Ar. However, PFCs, N₂O, and the like have a global warming potential (GWP) that is hundreds to tens of thousands of times greater than that of CO₂, and the atmospheric lifetime thereof is also much longer compared to that of CO₂. Therefore, devastating effects are caused, even if a small amount of such gas is discharged to the atmosphere. Furthermore, perfluorocarbons represented by CF₄ and C₂F₆ are stable when it comes to a C-F bond (a bond energy thereof is as large as 130 kcal/mol), and thus decomposition thereof is known to not be easy. Accordingly, various technologies have been developed to abate used PFCs, N₂O, and the like from an exhaust gas.

As a technology for abating the exhaust gas that includes hardly decomposable PFCs, N₂O, and the like, for example, Japanese Laid-Open Patent Publication No. 2002-188810 discloses an exhaust gas treatment device in which dust and the like included in a noxious exhaust gas is eliminated in an inlet scrubber, then the exhaust gas is thermally decomposed in an exhaust gas treatment furnace provided with an electric heater, and the decomposed gas is abated through gas-liquid contact in a wet outlet scrubber.

### SUMMARY OF THE DISCLOSURE

However, the above conventional technology has the following problems. Specifically, when PFCs in an exhaust gas contain hardly decomposable CF₄ as a main component, an electric heater has to be used at a very high temperature, for example, 1500° C. or higher. However, when the electric heater is used within such a temperature range, heat is easily diffused around the exhaust gas treatment furnace through a furnace wall thereof. Thus, in order to prevent such heat diffusion, a heat-insulating material that is installed on the outer periphery of the furnace wall needs to be made thicker, resulting in the upsizing of the exhaust gas treatment furnace.

“The 2030 Agenda for Sustainable Development” was adopted in the United Nations Summit in September 2015. After that, various discussions and investigations about, for example, efficient use of energy in future have been conducted. Under these circumstances, also, regarding the above conventional exhaust gas treatment device that includes an electric heater and that consumes a relatively large amount of power as energy during heating, the needs for high efficiency and energy saving brought about by such high efficiency are growing.

In addition, as described above, a large amount of nitrogen content derived from N₂O, N₂, or the like is included in a semiconductor manufacturing exhaust gas, and thus, there is a problem that, when the exhaust gas is thermally decomposed, a large amount of thermal NOx (nitrogen oxides) is produced as a byproduct.

Therefore, a main object of the present disclosure is to provide an exhaust gas treatment furnace that is more compact compared to conventional ones and can more efficiently utilize electrical energy, and that can remarkably improve efficiency of abating an exhaust gas consisting of various types of abatement targets, for example, a semiconductor manufacturing exhaust gas, and an exhaust gas treatment device in which the exhaust gas treatment furnace is used. In addition, a secondary object of the present disclosure is to reduce the production of byproducts of thermal NOx associated with thermal decomposition of the exhaust gas.

In order to achieve the above-described object, in the present disclosure, an exhaust gas treatment furnace that thermally decomposes an exhaust gas E discharged mainly through a semiconductor manufacturing process has a configuration described below, for example, as shown in FIG. 1.

That is, the exhaust gas treatment furnace includes: a furnace body 12 that has a sealed vertical tubular shape, and that includes a gas treatment space 12a formed inside and a gas discharge port 12b formed in a center part of a wall surface of a bottom thereof; a long electric heater 14 that is hung from a center part of a surface of a ceiling of the furnace body 12 and that heats the gas treatment space 12a; and a ceramic inner tube member 16 of which a rear end portion is mounted on a surface, on an inner side, of the bottom of the furnace body 12 so as to enclose a circumferential edge of the gas discharge port 12b, and of which a front end portion is open at a position close to the surface of the ceiling of the furnace body 12 and encloses an outer circumference of the electric heater 14. A gas introduction port 12c is formed in one of a wall surface of the ceiling and the wall surface of the bottom of the furnace body 12, in such a manner that the exhaust gas E inside the gas treatment space 12a flows along an axial direction on an outer circumference surface side of the ceramic inner tube member 16, then reverses, and flows along the axial direction on an inner circumference surface side of the ceramic inner tube member 16.

The present disclosure, for example, exhibits the following effect.

When the electric heater 14 is operated to start heating inside the furnace body 12, the inside (internal space) of the ceramic inner tube member 16 is heated first, and the heat is transferred via the ceramic inner tube member 16 to the outside. Here, in the exhaust gas treatment furnace of the present disclosure, the exhaust gas E inside the gas treatment space 12a flows along the axial direction on the outer circumference surface side of the ceramic inner tube member 16, (then reverses the flowing direction,) and flows along the axial direction on the inner circumference surface side of the ceramic inner tube member 16. Thus, the exhaust gas E flowing on the outer circumference surface side of the ceramic inner tube member 16 is preheated, before the exhaust gas E flows onto the inner circumference surface side of the ceramic inner tube member 16 (=an internal space in which substantial thermal decomposition of the exhaust gas E is performed). In addition, a layer composed of the exhaust gas E flowing along the axial direction on the outer circumference surface side of the ceramic inner tube member 16 serves as an insulation layer, and thus the heat inside the gas treatment space 12a can also be inhibited from escaping via a furnace wall of the furnace body 12 to the outside of the furnace.

In the present disclosure, for example, as shown in FIG. 2, the exhaust gas treatment furnace optionally further includes: a reducing gas supply means 40 that supplies a reducing gas G toward the exhaust gas E supplied into the furnace body 12; and an oxygen supply means 42 that supplies oxygen toward the exhaust gas E supplied into the furnace body 12.

In this case, the reducing gas G and oxygen are added when the exhaust gas E is thermally decomposed inside the furnace body 12, so that not only is efficiency of thermally decomposing the exhaust gas E improved, but also the amount of thermal NOx produced as a byproduct can be reduced.

In addition, in the present disclosure, for example, as shown in FIGS. 3A and 3B, one or a plurality of ceramic outer tube members 18 are placed outward of the ceramic inner tube member 16 inside the gas treatment space 12a so as to enclose the ceramic inner tube member 16 and to be concentric with the ceramic inner tube member 16 in a plan view. Among the ceramic outer tube members 18, an odd-numbered one when counted from the ceramic inner tube member 16 side is hung from the surface of the ceiling of the furnace body 12, and an even-numbered one when counted from the ceramic inner tube member 16 side is erected on the surface of the bottom of the furnace body 12. A gas introduction port 12c is optionally formed in one of the wall surface of the ceiling and the wall surface of the bottom of the furnace body 12, in such a manner that the exhaust gas E inside the gas treatment space 12a flows along an axial direction on an outer circumference surface side of the ceramic outer tube member 18 positioned on an outermost layer, then reverses, flows along the axial direction on an inner circumference surface side of the ceramic outer tube member 18 positioned on the outermost layer while flowing along the axial direction on the outer circumference surface side of the ceramic inner tube member 16, then reverses, and flows along the axial direction on the inner circumference surface side of the ceramic inner tube member 16.

In this case, not only can the heat transferred via the ceramic inner tube member 16 to the outside be more effectively recovered using the exhaust gas E, but also the heat inside the gas treatment space 12a can be further inhibited from escaping via the furnace wall of the furnace body 12 to the outside of the furnace body 12.

A second aspect of the present disclosure is directed to an exhaust gas treatment device in which the exhaust gas treatment furnace is used, and the exhaust gas treatment device includes: the exhaust gas treatment furnace according to any one of the above; and at least one of an inlet scrubber 20 that performs liquid scrubbing of a treatment-target exhaust gas E to be introduced into the exhaust gas treatment furnace, in advance, and an outlet scrubber 22 that performs cooling and liquid scrubbing of the exhaust gas E thermally decomposed in the exhaust gas treatment furnace.

The present disclosure can provide an exhaust gas treatment furnace that is not only more compact compared to conventional ones but also can more efficiently utilize electrical energy, and that can remarkably improve efficiency of abating a semiconductor manufacturing exhaust gas consisting of various types of abatement targets, for example, CF₄ or N₂O, and an exhaust gas treatment device in which the exhaust gas treatment furnace is used. In addition, the amount of thermal NOx produced as a byproduct when the exhaust gas is thermally decomposed can be remarkably reduced.

### BRIEF DESCRIPTION OF THE DRAWINGS

FIG. 1 illustrates an example of an exhaust gas treatment device in which an exhaust gas treatment furnace is used, according to an embodiment (first embodiment) of the present disclosure;

FIG. 2 illustrates an example of the exhaust gas treatment device in which the exhaust gas treatment furnace is used, according to another embodiment (modification of the first embodiment) of the present disclosure; and

FIGS. 3A and 3B each show an exhaust gas treatment furnace according to another embodiment (second embodiment) of the present disclosure, FIG. 3A is a partial vertical cross-sectional view in a front view, and FIG. 3B is a sectional view taken along a line A-A′ in FIG. 3A.

### DETAILED DESCRIPTION OF THE EMBODIMENTS

Hereinafter, embodiments of an exhaust gas treatment furnace suitable for abating an exhaust gas discharged mainly through a semiconductor manufacturing process, and an exhaust gas treatment device in which the exhaust gas treatment furnace is used, according to the present disclosure, will be described with reference to the drawings.

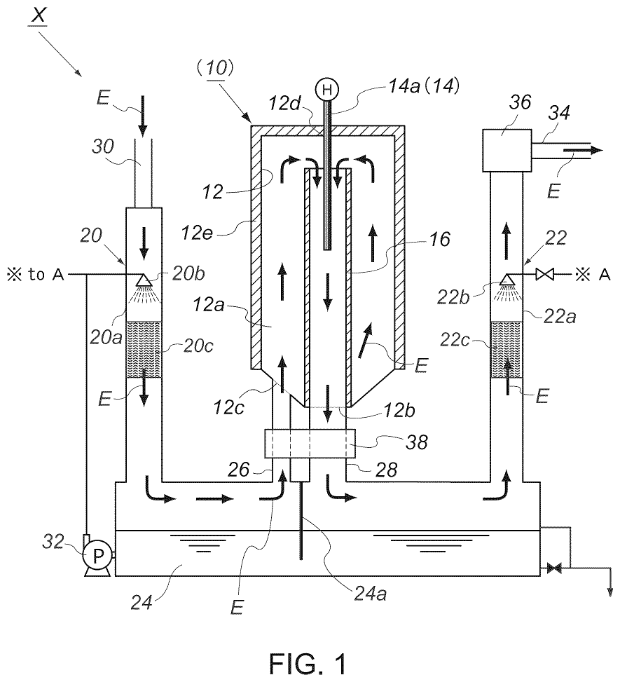

FIG. 1 illustrates an example of an exhaust gas treatment device X in which an exhaust gas treatment furnace 10 is used, according to an embodiment (first embodiment) of the present disclosure. The exhaust gas treatment device X is a device that performs an abatement process by thermally decomposing an exhaust gas E containing PFCs, N₂O, and the like discharged from an exhaust source (mainly, semiconductor manufacturing process), which is not shown, and is mainly composed of the exhaust gas treatment furnace 10, an inlet scrubber 20, and an outlet scrubber 22.

The exhaust gas treatment furnace 10 is a device that thermally decomposes PFCs, N₂O, and the like in the exhaust gas E by using an electric heater 14, and is mainly composed of a furnace body 12, the electric heater 14, and a ceramic inner tube member 16.

The furnace body 12 or at least an inner surface thereof is made of a refractory material such as a castable refractory material, and is a sealed tubular container body (sealed cylindrical container body in the illustrated embodiment) including a gas treatment space 12a formed therein. As shown in FIG. 1, when used, the furnace body 12 is erected such that a plane portion (of the furnace body 12) faces the top-and-bottom direction, and a gas discharge port 12b is formed in the center part of the wall surface of the bottom of the furnace body 12. In the present embodiment, the ceramic inner tube member 16 is mounted in the furnace body 12 so as to enclose the gas discharge port 12b, and a gas introduction port 12c for introducing the treatment-target exhaust gas E into the gas treatment space 12a inside the furnace body 12 is formed at a position away from the gas discharge port 12b in the wall surface of the bottom of the furnace body 12. Thus, the exhaust gas E introduced in the gas treatment space 12a of the furnace body 12 flows along the axial direction on the outer circumference surface side of the ceramic inner tube member 16, then reverses, and flows along the axial direction on the inner circumference surface side of the ceramic inner tube member 16. Further, a heater insertion opening 12d through which the electric heater 14 is inserted is formed in the ceiling of the furnace body 12, and a heat insulating material 12e is installed on the outer circumference surface and an outer wall side of the ceiling of the furnace body 12.

In the present embodiment, the furnace body 12 is formed in a sealed cylindrical shape. However, the furnace body 12 may have any shape as long as the furnace body 12 has a tubular shape with both ends sealed, for example, the furnace body 12 may have a sealed polygonal tubular shape or the like.

The electric heater 14 is a heat source for heating the gas treatment space 12a inside the furnace body 12, and includes a heating element 14a having a long bar shape. The heating element 14a may be appropriately selected from known types according to the thermal decomposition temperature of the treatment-target exhaust gas E or the kind of thermal decomposition product. For example, in a case where the exhaust gas E includes PFCs as a treatment-target component, an element that has corrosion resistance to HF (hydrogen fluoride) produced as a byproduct by thermally decomposing PFCs in the exhaust gas E and that can generate heat at high temperatures, for the heating element 14a, is used. Specifically, examples thereof include ceramic materials such as silicon carbide (SiC), molybdenum disilicide (MoSi₂), and lanthanum chromite (LaCrO₃), and materials formed by helically winding a metal wire such as a nichrome wire or Kanthal® (registered trademark of Sandvik AB) wire, which is a heating resistor, inside a protective pipe made of ceramic such as alumina or metal such as Hastelloy® (registered trademark of Haynes International). Among the materials, the heating element 14a made of ceramic may be used.

The heating element 14a is inserted in an internal space of the furnace body 12 through the heater insertion opening 12d provided at the center part of the wall of the ceiling of the furnace body 12, whereby the electric heater 14 is detachably mounted. Thus, the electric heater 14 is hung from the ceiling of the furnace body 12, and the outer circumference of the long heating element 14a is enclosed by the ceramic inner tube member 16 so as to be spaced from each other. In the illustrated embodiment, one electric heater 14 is hung. However, the number of the electric heaters 14 installed in the furnace body 12 is not limited to one, and may be two or more, for example. In addition, in a case where a plurality of the electric heaters 14 are installed, the electric heaters 14 may also be placed on the outer circumference surface side of the ceramic inner tube member 16.

The ceramic inner tube member 16 is for controlling the flow of the exhaust gas E inside the gas treatment space 12a, and is a cylindrical member made of ceramic such as alumina (Al₂O₃), zirconia (ZrO₂), silicon carbide (SiC), silicon nitride (Si₃N₄), molybdenum disilicide (MoSi₂), or lanthanum chromite (LaCrO₃) and having both end surfaces open in the longitudinal direction. One end in the longitudinal direction of the ceramic inner tube member 16 is mounted on the wall surface, on the inner side, of the bottom of the furnace body 12 so as to enclose the above-described gas discharge port 12b. The ceramic inner tube member 16 extends across the gas treatment space 12a of the furnace body 12 such that the other end in the longitudinal direction of the ceramic inner tube member 16 is located at a position close to a surface of the ceiling of the furnace body 12.

In the present embodiment, the ceramic inner tube member 16 is formed in a cylindrical shape. However, the ceramic inner tube member 16 may have any shape as long as the ceramic inner tube member 16 has a tubular shape with both ends open, for example, the ceramic inner tube member 16 may have a polygonal tubular shape or the like.

Although not shown, for example, a temperature measurement means such as a thermocouple for detecting the temperature of the gas treatment space 12a is mounted in the exhaust gas treatment furnace 10 configured as described above, and the temperature data (temperature signal) detected by the temperature measurement means is provided via a signal line to a control means composed of a central processing unit (CPU), a memory, an input device, a display device, and the like. A power-supply unit or the like (not shown) is also connected to the control means, and the above various devices are controlled by the control means.

In addition, the exhaust gas treatment furnace 10 configured as described above is placed on a storage tank 24 in which a chemical liquid such as water is stored. An upper end of an introduction pipe 26 having approximately the same inner diameter as the gas introduction port 12c is connected communicably to the gas introduction port 12c, and a lower end of the introduction pipe 26 is connected so as to communicate with a region where the exhaust gas E (that has not been thermally decomposed) having passed through the inlet scrubber 20 described later flows in the storage tank 24. In addition, an upper end of a discharge pipe 28 having approximately the same inner diameter as the gas discharge port 12b is also connected communicably to the gas discharge port 12b, and a lower end of the discharge pipe 28 is connected so as to communicate with a different region in the storage tank 24 from the region where the exhaust gas E (that has not been thermally decomposed) having passed through the inlet scrubber 20 flows.

The inlet scrubber 20 is a wet scrubber that eliminates dust, water-soluble components, and the like contained in the exhaust gas E to be introduced into the exhaust gas treatment furnace 10, and includes a straight-tube type scrubber body 20a, a spray nozzle 20b installed in the vicinity of the top inside the scrubber body 20a and designed for spraying a chemical liquid such as water in an atomized state, and a filling material 20c for promoting gas-liquid contact between the exhaust gas E and the chemical liquid sprayed through the spray nozzle 20b. Among these, the filling material 20c is installed as necessary. The inlet scrubber 20 communicates with an exhaust gas generation source (not shown) such as a semiconductor manufacturing apparatus through an exhaust gas duct 30.

In addition, the inlet scrubber 20 is erected on the storage tank 24 (see FIG. 1), or the inlet scrubber 20 is placed separately from the storage tank 24 and is connected to the storage tank 24 via piping so as to deliver drainage into the storage tank 24, although not shown. A circulation pump 32 is installed between the spray nozzle 20b and the storage tank 24 so as to raise the chemical liquid stored in the storage tank 24 up to the spray nozzle 20b.

In the present embodiment shown in FIG. 1, not only drainage from the inlet scrubber 20 but also the exhaust gas E subjected to liquid scrubbing is allowed to be delivered into the storage tank 24, and a space (upper space) between a liquid surface and a ceiling surface of the storage tank 24 is utilized as an exhaust gas passage. Here, a sign 24a in FIG. 1 denotes a “partition wall” serving as a division for preventing the exhaust gas E subjected to liquid scrubbing in the inlet scrubber 20 from flowing into the outlet scrubber 22 without passing through the exhaust gas treatment furnace 10.

The outlet scrubber 22 is a wet scrubber that cools the thermally decomposed exhaust gas E that has passed through the exhaust gas treatment furnace 10 and that finally eliminates dust, water-soluble components, and the like produced as a byproduct through thermal decomposition, from the exhaust gas E. In the present embodiment, the outlet scrubber 22 includes a straight-tube type scrubber body 22a, a downward-oriented spray nozzle 22b installed in the vicinity of the top inside the scrubber body 22a and designed for spraying a chemical liquid such as water from the above so as to face the flowing direction of the exhaust gas E, and a filling material 22c for promoting gas-liquid contact between the exhaust gas E and the chemical liquid sprayed through the spray nozzle 22b. Among these, the filling material 22c is installed as necessary. The outlet scrubber 22 is erected in a different region on the storage tank 24 from the region where the exhaust gas E (that has not been thermally decomposed) having passed through the inlet scrubber 20 flows, and the thermally decomposed exhaust gas E (discharged into the storage tank 24 through the discharge pipe 28) is introduced through a lower opening, while the chemical liquid that has become drainage water after being supplied through the spray nozzle 22b is delivered into the storage tank 24.

In the illustrated embodiment, as in the above-described inlet scrubber 20, a circulation pump 32 is installed between the spray nozzle 22b and the storage tank 24 so as to raise the chemical liquid stored in the storage tank 24 up to the spray nozzle 22b. However, instead of the chemical liquid stored in the storage tank 24, a new chemical liquid such as clean water may be supplied into the spray nozzle 22b.

An exhaust fan 36 for discharging the treated exhaust gas E to the atmosphere is connected to an atmosphere discharge piping system 34 in the vicinity of a top outlet of the outlet scrubber 22.

Corrosion-resistant lining or coating is applied, using vinyl chloride, polyethylene, unsaturated polyester resin, fluororesin, or the like, to parts other than the exhaust gas treatment furnace 10 in the exhaust gas treatment device X of the present embodiment, to protect each part from corrosion due to corrosive components such as hydrofluoric acid contained in the exhaust gas E or produced through decomposition of the exhaust gas E. In addition, a sign 38 in FIG. 1 denotes a heat exchanger that allows heat exchange between the exhaust gas E flowing through the introduction pipe 26 and the exhaust gas E flowing through the discharge pipe 28, and that is installed as necessary.

Further, when the exhaust gas E is abated using the exhaust gas treatment device X configured as described above, first, an operation switch (not shown) of the exhaust gas treatment device X is turned on to operate the electric heater 14 of the exhaust gas treatment furnace 10, thereby starting heating inside the exhaust gas treatment furnace 10.

When the temperature inside the gas treatment space 12a has reached a specified temperature corresponding to the type of treatment-target exhaust gas E, the exhaust fan 36 operates to start introduction of the exhaust gas E into the exhaust gas treatment device X. Then, the exhaust gas E passes through the inlet scrubber 20, the exhaust gas treatment furnace 10, and the outlet scrubber 22 in this order, to abate abatement-target components (e.g., PFCs, N₂O, and the like) in the exhaust gas E. In addition, the control means (not shown) controls the amount of power to be supplied to the electric heater 14 of the exhaust gas treatment furnace 10 such that the temperature inside the gas treatment space 12a is maintained at the specified temperature.

In the exhaust gas treatment device X of the present embodiment, when the electric heater 14 is operated to start heating inside the furnace body 12, the inside (internal space) of the ceramic inner tube member 16 is heated first, and the heat is transferred via the ceramic inner tube member 16 to the outside. Here, in the exhaust gas treatment furnace 10 of the present embodiment, the exhaust gas E inside the gas treatment space 12a flows along the axial direction on the outer circumference surface side of the ceramic inner tube member 16, (then reverses the flowing direction,) and flows along the axial direction on the inner circumference surface side of the ceramic inner tube member 16. Thus, the exhaust gas E flowing on the outer circumference surface side of the ceramic inner tube member 16 is preheated, before the exhaust gas E flows onto the inner circumference surface side of the ceramic inner tube member 16 (=an internal space in which substantial thermal decomposition of the exhaust gas E is performed). In addition, a layer composed of the exhaust gas E flowing along the axial direction on the outer circumference surface side of the ceramic inner tube member 16 serves as an insulation layer, and thus the heat inside the gas treatment space 12a can also be inhibited from escaping via the furnace wall of the furnace body 12 to the outside of the furnace.

In the above-described embodiment, both the inlet scrubber 20 and the outlet scrubber 22 are provided in the exhaust gas treatment device X. However, the inlet scrubber 20 and the outlet scrubber 22 are provided as necessary, and thus only one of the inlet scrubber 20 and the outlet scrubber 22 may be provided.

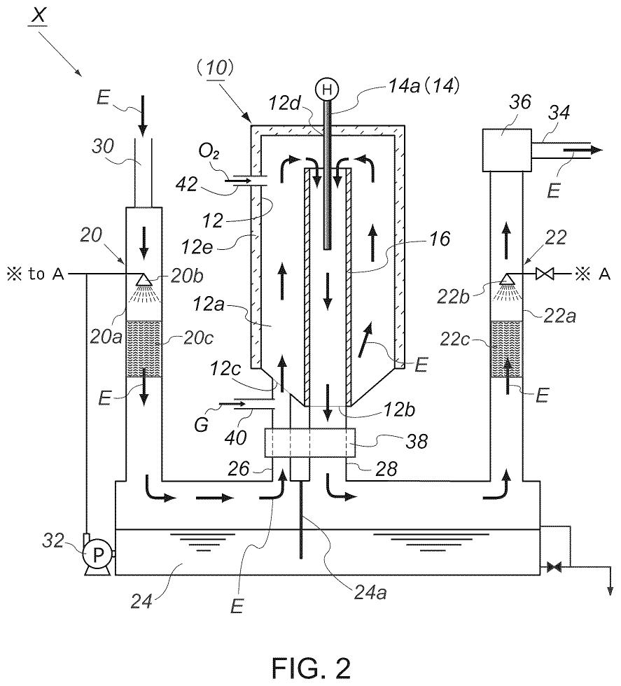

In addition, the above-described embodiment may be changed so as to have a configuration shown in FIG. 2. That is, a reducing gas supply means 40 that supplies a reducing gas G toward the exhaust gas E supplied into the furnace body 12, and an oxygen supply means 42 that supplies oxygen toward the exhaust gas E supplied into the furnace body 12, are provided. The reducing gas supply means 40 and the oxygen supply system 42 may be, for example, gas supply systems including a pressurized storage vessel, flow control valves, and delivery piping configured to introduce gas into the furnace body. Here, examples of the reducing gas G to be supplied toward the exhaust gas E by the reducing gas supply means 40 include hydrogen, carbon monoxide, ammonia, and hydrocarbon. In addition, in an embodiment in FIG. 2, the reducing gas supply means 40 is connected in the vicinity of the gas introduction port 12c, and the oxygen supply means 42 is connected at the upper part of the furnace body 12. However, the positions at which the reducing gas supply means 40 and the oxygen supply means 42 are connected are not limited thereto, and can be any position as long as the exhaust gas E, the reducing gas G, and the oxygen can be sufficiently mixed in the gas treatment space 12a of the furnace body 12.

In the exhaust gas treatment device X in FIG. 2 configured as described above, in a case where a device in which power consumption is 7.0 KW, a treatment gas flow rate for N₂ (carrier gas) is 180 L/min., a treatment gas flow rate for CF₄ is 1.25 L/min., and a set temperature for the electric heater 14 is 1320° C., for example, is used, methane-dominant natural gas (13A) as the reducing gas G at 3.5 to 5.0 L/min, and oxygen at 8.0 to 11.5 L/min. are added, so that efficiency of abating CF₄ can achieve 90% or more, and the amount of NOx produced as a byproduct can achieve 10 ppm or less.

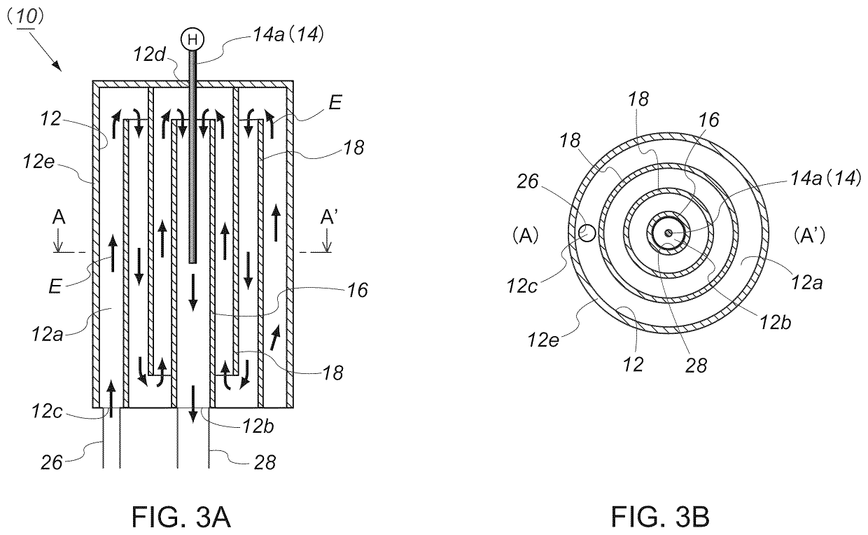

Next, an exhaust gas treatment furnace 10 according to a second embodiment shown in FIGS. 3A and 3B will be described. The exhaust gas treatment furnace 10 of the second embodiment is different from the above-described exhaust gas treatment furnace 10 of the first embodiment in that the exhaust gas treatment furnace 10 of the second embodiment includes a ceramic outer tube member 18. Since components other than the above are the same as those of the above-described first embodiment, the description of the first embodiment is referred to without repeatedly describing the components of the present embodiment.

Similarly to the above-described ceramic inner tube member 16, the ceramic outer tube member 18 is for controlling the flow of the exhaust gas E inside the gas treatment space 12a, and is a cylindrical member made of ceramic such as alumina (Al₂O₃), zirconia (ZrO₂), silicon carbide (SiC), silicon nitride (Si₃N₄), molybdenum disilicide (MoSi₂), or lanthanum chromite (LaCrO₃) and having both end surfaces open in the longitudinal direction. One or a plurality of the ceramic outer tube members 18 are provided so as to enclose the outer side of the ceramic inner tube member 16, and the ceramic outer tube members 18 and the ceramic inner tube member 16 are placed concentrically in a plan view (see FIG. 3B). In the embodiment shown in FIGS. 3A and 3B, two ceramic outer tube members 18 are installed.

In addition, among the above-described ceramic outer tube members 18, an odd-numbered one when counted from the ceramic inner tube member 16 side is hung from the surface of the ceiling of the furnace body 12, and an even-numbered one when counted from the ceramic inner tube member 16 side is erected on the surface of the bottom of the furnace body 12 (see FIG. 3A). The gas introduction port 12c is formed in one of the wall surface of the ceiling and the wall surface of the bottom of the furnace body 12, in such a manner that the exhaust gas E inside the above-described gas treatment space 12a flows along the axial direction on the outer circumference surface side of the ceramic outer tube member 18 positioned on the outermost layer, then reverses, flows along the axial direction on the inner circumference surface side of the ceramic outer tube member 18 positioned on the outermost layer while flowing along the axial direction on the outer circumference surface side of the ceramic inner tube member 16, and then flows along the axial direction on the inner circumference surface side of the ceramic inner tube member 16. In the embodiment shown in FIGS. 3A and 3B, since the ceramic outer tube member 18 positioned on the outermost layer is an even-numbered (second) one when counted from the ceramic inner tube member 16 side, the ceramic outer tube member 18 positioned on the outermost layer is erected on the surface of the bottom of the furnace body 12. Therefore, in order to cause the exhaust gas E to flow along the axial direction on the outer circumference surface side of the ceramic outer tube member 18 positioned on the outermost layer, then to reverse, and to flow along the axial direction on the inner circumference surface side of the ceramic outer tube member 18 positioned on the outermost layer, the gas introduction port 12c is formed in the wall surface of the bottom of the furnace body 12, between an inner wall of the furnace body 12 and the ceramic outer tube member 18 positioned on the outermost layer.

In the exhaust gas treatment furnace 10 of the present embodiment, not only can the heat from the electric heater 14 transferred via the ceramic inner tube member 16 to the outside be more effectively recovered using the exhaust gas E, but also the heat inside the gas treatment space 12a can be further inhibited from escaping via the furnace wall of the furnace body 12 to the outside of the furnace.

In the above-described exhaust gas treatment furnace 10 of the second embodiment, each ceramic outer tube member 18 is formed in a cylindrical shape. However, the ceramic outer tube member 18 may have any shape as long as the ceramic outer tube member 18 has a tubular shape with both ends open, for example, the ceramic outer tube member 18 may have a polygonal tubular shape or the like. In a case where the ceramic outer tube member 18 and the ceramic inner tube member 16 are each formed in a polygonal tubular shape or the like, the ceramic outer tube member 18 and the ceramic inner tube member 16 are placed such that circumscribed or inscribed circles thereof are concentric in a plan view.

In addition, in each of the above-described exhaust gas treatment furnaces 10 of the first and second embodiments, one gas introduction port 12c is formed in the furnace body 12. However, a plurality of the gas introduction ports 12c may be provided and each connected to the introduction pipe 26 such that the exhaust gas E flows in the circumferential direction evenly over the entire gas treatment space 12a, for example.

Moreover, as a matter of course, various changes conceivable by those skilled in the art can be made.

What is claimed is:

1. An exhaust gas treatment furnace that thermally decomposes an exhaust gas, comprising:
a furnace body that has a sealed vertical tubular shape, and that includes a gas treatment space formed inside and a gas discharge port formed in a center part of a wall surface of a bottom thereof;
a long electric heater that is hung from a center part of a surface of a ceiling of the furnace body and that heats the gas treatment space; and
a ceramic inner tube member of which a rear end portion is mounted on a surface, on an inner side, of the bottom of the furnace body so as to enclose a circumferential edge of the gas discharge port, and of which a front end portion is open at a position close to the surface of the ceiling of the furnace body and encloses an outer circumference of the electric heater,
wherein a gas introduction port is formed in one of a wall surface of the ceiling and the wall surface of the bottom of the furnace body, in such a manner that the exhaust gas inside the gas treatment space flows along an axial direction on an outer circumference surface side of the ceramic inner tube member, then reverses, and flows along the axial direction on an inner circumference surface side of the ceramic inner tube member.

2. The exhaust gas treatment furnace according to claim 1, further comprising:
a reducing gas supply means that supplies a reducing gas toward the exhaust gas supplied into the furnace body; and
an oxygen supply means that supplies oxygen toward the exhaust gas supplied into the furnace body.

3. The exhaust gas treatment furnace according to claim 1, wherein:
one or a plurality of ceramic outer tube members are placed outward of the ceramic inner tube member inside the gas treatment space so as to enclose the ceramic inner tube member and to be concentric with the ceramic inner tube member in a plan view,
among the ceramic outer tube members, an odd-numbered one when counted from the ceramic inner tube member side is hung from the surface of the ceiling of the furnace body, and an even-numbered one when counted from the ceramic inner tube member side is erected on the surface of the bottom of the furnace body, and
the gas introduction port is formed in one of the wall surface of the ceiling and the wall surface of the bottom of the furnace body, in such a manner that the exhaust gas inside the gas treatment space flows along an axial direction on an outer circumference surface side of the ceramic outer tube member positioned on an outermost layer, then reverses, flows along the axial direction on an inner circumference surface side of the ceramic outer tube member positioned on the outermost layer while flowing along the axial direction on the outer circumference surface side of the ceramic inner tube member, then reverses, and flows along the axial direction on the inner circumference surface side of the ceramic inner tube member.

4. An exhaust gas treatment device comprising:
the exhaust gas treatment furnace according to claim 1; and
at least one of an inlet scrubber that performs liquid scrubbing of a treatment-target exhaust gas to be introduced into the exhaust gas treatment furnace, in advance, and an outlet scrubber that performs cooling and liquid scrubbing of the exhaust gas thermally decomposed in the exhaust gas treatment furnace.
